(19) United States
(12) Patent Application Publication
(10) Pub. No.: US 2007/0059451 A1
(43) Pub. Date: Mar. 15, 2007

(54) Clearcoat paint composition

(75) Inventors: Swaminathan Ramesh, Canton, MI (US); Heinz-Peter Rink, Munster (DE)

Correspondence Address: BASF CORPORATION, 1609 BIDDLE AVENUE, MAIN BUILDING, WYANDOTTE, MI, 48192, US

(73) Assignee: BASF Corporation, Southfield, MI (US)

(21) Appl. No.: 11/227,891

(22) Filed: Sep. 15, 2005

(51) Int. Cl. B05D 7/00

(52) U.S. Cl. 427/384; 427/402

(57) ABSTRACT

A coating composition including an aqueous dispersion of a copolymerization product of a mixture of monomers including carbamate-functional and (meth)acrylic monomers, some having carboxylic acid-functionality. The monomer mixture is essentially free of hydroxyl monomer. The coating can be applied on a polycarbonate substrate. The coating composition may be a clearcoat coating composition, preferably an automotive clearcoat coating composition. The invention provides a method of producing such a coating and application on a substrate, particularly as a basecoat/clearcoat composite coating, with the coating composition of the invention preferably being at least the clearcoat of the composite coating. If the substrate is a polycarbonate, the clearcoat can be applied directly on the substrate without any primer or basecoat.

### FIELD OF THE INVENTION

The present invention relates to thermoset clearcoat compositions, and more particularly, to automotive topcoat coatings.

### BACKGROUND OF THE INVENTION

Curable, or thermosettable, coating compositions are widely used in the coatings art, particularly for topcoats in the automotive and industrial coatings industry. Basecoat-clearcoat composite coatings are particularly useful as topcoats for which exceptional gloss, depth of color, distinctness of image, or special metallic effects are desired. The automotive industry has made extensive use of these coatings for automotive body panels. Automotive clearcoats must meet many performance requirements. They must be smooth and glossy to provide the desired aesthetic appeal. They must also be durable, both to preserve the coating appearance and to protect the steel substrate, by resisting scratching and marring and also degradation from UV light in sunlight, environmental etching, and heat.

In the new era of automobile design and production, polycarbonate materials are becoming increasingly popular as an alternative material for use in automotive body components. Polycarbonate materials generally have acceptable levels of strength and clarity, but lack high levels of abrasion resistance and chemical resistance.

Carbamate-functional materials have found particular utility in coating compositions as cross-linkable resins. Clearcoat compositions containing carbamate-functional acrylic polymers can provide significant advantages over other coating compositions, such as hydroxy-functional acrylic/melamine coating compositions as a solution to the problem of environmental etch. Environmental etch, or acid etch, results in spots or marks on or in the coating that often cannot be rubbed out.

While such polymers and compositions containing carbamate-functional materials provide a significant improvement over the prior art, improvements in some areas are still desirable. In particular, it would be advantageous to provide polymers exhibiting the ability to go over polycarbonate materials as well as steel and other substrates, while still possessing the positive environmental etch and performance characteristics of carbamate-functional acrylics. This would allow a low VOC high performance coating system. It would also be advantageous to provide polymers exhibiting the ability to be used in an aqueous dispersion that can be applied to polycarbonate surfaces.

Thus, there remains a need for coating compositions that have improved coating and adhesion capabilities that and can be applied using existing equipment in plants currently configured to handle more traditional coatings technology. Such a coating composition still must provide a cured coating having the desired physical properties.

### SUMMARY OF THE INVENTION

In one embodiment, the present invention provides a process for coating a substrate with a low volatile emission composite coating. The process includes applying a primer coating composition over a substrate and curing the primer composition to form a primer coating layer. A basecoat coating composition is applied over the primer coating layer, and a clearcoat coating composition is applied over the basecoat coating composition. The applied basecoat and clearcoat compositions are cured to form a composite coating layer. At least one of the primer, basecoat, and clearcoat coating compositions includes a water based dispersion comprising an aqueous emulsion of copolymerized acrylic monomers, methacrylic monomers, and carbamate-functional monomers. The dispersion is essentially free of hydroxyl monomer.

In another embodiment, the present invention provides a method of coating a polycarbonate substrate. The method includes preparing a composition comprising an aqueous dispersion of copolymerized acrylic monomers, methacrylic monomers, and carbamate-functional monomers. Preferably, the dispersion is essentially free of hydroxyl monomer. The composition is applied to a polycarbonate substrate and cured. In various embodiments, the dispersion is prepared by copolymerizing at least one carbamate-functional monomer with a carboxylic acid-functional monomer in a solvent. The resulting solution is salted with an amine and used to form a dispersion in water.

In a particularly advantageous embodiment, the coating composition of the invention is a clearcoat coating composition, preferably an automotive clearcoat coating composition. The invention further provides an article, such as an automotive vehicle, having a surface coated with a coating derived from the coating composition of the invention, particularly a composite coating having a basecoat layer and a clearcoat layer, and a method of producing such a coating on a substrate, particularly as a basecoat/clearcoat composite coating, with the coating composition of the invention preferably forming at least the clearcoat of the composite coating. In various embodiments, the article comprises a polycarbonate material.

### DETAILED DESCRIPTION OF THE INVENTION

The following description of the preferred embodiment(s) is merely exemplary in nature and is in no way intended to limit the invention, its application, or uses.

“A” and “an” as used herein indicate “at least one” of the item is present; a plurality of such items may be present, when possible. “About” when applied to values indicates that the calculation or the measurement allows some slight imprecision in the value (with some approach to exactness in the value; approximately or reasonably close to the value; nearly). If, for some reason, the imprecision provided by “about” is not otherwise understood in the art with this ordinary meaning, then “about” as used herein indicates a possible variation of up to 5% in the value.

The clearcoat composition of the present invention includes an aqueous dispersion of a copolymer of (meth)acrylate monomers with carbamate-functionality that are copolymerized with other acrylic or methacrylic monomers, some preferably having acidic functionality. The dispersion is essentially free of hydroxyl monomer. The term “(meth)acrylate” as used herein, refers to both acrylate and methacrylate. Polymers include both oligomers of relatively low molecular weight and polymers of relatively high molecular weight. The term “copolymers” is contemplated to include oligomers and polymers polymerized from more than one kind of monomer.

It will be appreciated that the term “functional”, as used in this description, refers to the potential for crosslinking to occur after formation of a polymeric emulsion with an external crosslinking agent.

A carbamate group according to the invention may be represented by the structure 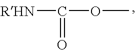
in which R′ is H or alkyl. Preferably, R′ is H or alkyl of from 1 to about 4 carbon atoms, and more preferably R′ is H (a primary carbamate). In various embodiments, carbamated propyl acrylic monomers such as 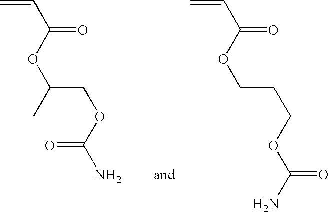
are preferred.

In various other embodiments, the copolymer of the present coating composition has at least one monomer unit including the condensation product of an ethylenically unsaturated carboxylic acid group and glycidyl ester of a mixture of tertiary acids having 9 to 11 carbon atoms having at least one methyl group on the α-carbon. In an alternate preferred embodiment, at least one monomer unit includes the polymerization product of the condensation product of a polymerizable glycidyl ester or ether and a mixture of tertiary acids having 9 to 11 carbon atoms having at least one methyl group on the α-carbon. Mixtures of tertiary acids having 9 to 11 carbon atoms having at least one methyl group on the α-carbon are available under the trademark VERSATIC™ acid, and the glycidyl ester of VERSATIC™ acid (also commonly called neodecanoic acid) is available under the brand name CARDURA® Resin E-10 from Shell Oil Company. Examples of polymerizable acids include, without limitation, acrylic acid, methacrylic acid, crotonic acid, fumaric acid, maleic acid, and itaconic acid, and anhydrides and monoalkyl esters of the difunctional acids. Examples of polymerizable glycidyl esters and ethers include, without limitation, glycidyl acrylate, glycidyl methacrylate, and allyl glycidyl ether.

With particular reference to one preferred acrylic polymer, then, the carbamate-functionality may be conveniently introduced by polymerizing a monomer having a carbamate group. It is also possible to polymerize with a monomer having functionality that may be reacted to supply a carbamate group after polymerization. Examples of addition polymerizable monomers having carbamate-functionality include, without limitation, carbamate propyl acrylate (CPA), carbamate propyl methacrylate (CPMA), and carbamate ethyl methacrylate (CEMA). Carbamate-functionality can be introduced to an acrylic polymer by a number of reactions, including, without limitation, converting hydroxyl groups to carbamates by other methods, such as those set out in Ohrbom, et al, U.S. Pat. No. 6,160,058 and McGee, et al., U.S. Pat. No. 5,726,244, both of which are incorporated herein by reference. The hydroxyl groups may arise from reacting a carboxylic acid group with a glycidyl compound or reacting glycidyl functionality with a carboxylic acid.

In one preferred embodiment, the acrylic polymer has an equivalent weight (with respect to the carbamate-functionality) of up to about 650 grams/equivalent, more preferably up to about 520 grams/equivalent, still more preferably up to about 435 grams/equivalent, more preferably up to about 370 grams/equivalent, and most preferably up to about 350 grams/equivalent. The acrylic polymer preferably has an equivalent weight (with respect to the carbamate-functionality) of at least about 260 grams/equivalent, more preferably at least about 290 grams/equivalent, and still more preferably at least about 310 grams/equivalent. The acrylic polymer preferably has equivalent weight in the range of 260 to 650 grams/equivalent, more preferably 290 to 520 grams/equivalent, still more preferably 290 to 435 grams/equivalent, even more preferably 290 to 370 grams/equivalent, and most preferably 310 to 350 grams/equivalent.

The acrylic polymer or polymers used as secondary dispersions (at least partially neutralized and then dispersed in water) should have a weight average molecular weight of at least about 2,400, preferably at least about 3,000, more preferably at least about 3,500, and particularly preferably at least about 4,000. Weight average molecular weight may be determined by gel permeation chromatography using polystyrene standard. In addition, the weight average molecular weight is preferably up to about 10,000, more preferably up to about 12,000, and still more preferably up to about 15,000. The acrylic polymer having carbamate-functionality has an equivalent weight, based on the carbamate functionality of preferably up to about 1,000 grams per equivalent, more preferably up to about 800 grams per equivalent, and even more preferably up to about 600 grams per equivalent. The carbamate equivalent weight is preferably at least about 350 grams per equivalent. A primary dispersion of acrylic carbamate resin could have a molecular weight in millions. The equivalent weight of these resins could be higher, for example, at least 1,500 g/carbamate and most preferably about 2,000 g/carbamate.

In various embodiments, the present invention provides polymerization of a monomer mixture that includes at least one carboxylic acid-functional monomer or at least one monomer that has a group that is converted to an acid group following polymerization, such as an anhydride group. Examples of acid-functional or anhydride-functional monomers include, without limitation, α,β-ethylenically unsaturated monocarboxylic acids containing 3 to 5 carbon atoms such as acrylic, methacrylic, crotonic acids, and optionally, the esters of those acids; α,β-ethylenically unsaturated dicarboxylic acids containing 4 to 6 carbon atoms and the anhydrides, monoesters such as maleic anhydride, maleic acid monomethyl ester, and fumaric acid, and optionally, the diesters of those acids; monomers containing a carboxyl group: sorbic, cinnamic, vinyl furoic, α-chlorosorbic, p-vinylbenzoic, maleic, fumaric, aconitic, atropic, and itaconic acids; and acid-functional derivatives of copolymerizable monomers, such as the hydroxyethyl acrylate half-ester of an anhydride, such as succinic acid. Other preferred half esters include lower alkyl esters containing 1 to 6 carbon atoms such as itaconic acid monomethyl ester, butyl acid itaconate, methyl acid fumarate, butyl acid fumarate, methyl acid maleate and butyl acid maleate.

In various embodiments, an acid-functional monomer is preferably included in an amount from about 5% to about 25% by weight of the monomers being polymerized, and preferably from about 12% to about 25% by weight of the monomers being polymerized.

Acid-functionality may also be provided by other known means, such as by reaction of an hydroxyl group with a cyclic anhydride or by hydrolysis of an ester, such as by hydrolysis of a tert-butyl methacrylate monomer unit. Alternately, it may be preferred to include an acid-functional monomer such as acrylic acid, methacrylic acid, or crotonic acid, or an anhydride monomer such as maleic anhydride or itaconic anhydride that may be hydrated after polymerization to generate acid groups.

The acrylic polymer may be polymerized using further co-monomers. Further representative examples of suitable esters of acrylic, methacrylic, and crotonic acids include, without limitation, those esters from reaction with saturated aliphatic and cycloaliphatic alcohols containing 1 to 20 carbon atoms, such as methyl, ethyl, propyl, isopropyl, n-butyl, isobutyl, tert-butyl, 2-ethylhexyl, lauryl, stearyl, cyclohexyl, trimethylcyclohexyl, tetrahydrofurfuryl, stearyl, sulfoethyl, and isobornyl acrylates, methacrylates, and crotonates. Representative examples of other ethylenically unsaturated polymerizable monomers include, without limitation, such compounds as fumaric, maleic, and itaconic anhydrides, monoesters, and diesters with alcohols such as methanol, ethanol, propanol, isopropanol, butanol, isobutanol, and tert-butanol. Representative examples of polymerization vinyl monomers include, without limitation, such compounds as vinyl acetate, vinyl propionate, vinyl ethers such as vinyl ethyl ether, vinyl and vinylidene halides, and vinyl ethyl ketone. Representative examples of aromatic or heterocyclic aliphatic vinyl compounds include, without limitation, such compounds as styrene, α-methyl styrene, vinyl toluene, tert-butyl styrene, and 2-vinyl pyrrolidone. The co-monomers may be used in any combination.

The acrylic polymer or polymers may be prepared using conventional techniques, such as by heating the monomers in the presence of a polymerization initiating agent and optionally chain transfer agents. The polymerization is preferably carried out in solution, although it is also possible to polymerize the acrylic polymer in bulk.

In preferred embodiments of the present invention, the dispersions are formulated by a primary dispersion process or a secondary dispersion process. Using a primary dispersion process, an emulsion is made by directly polymerizing a carbamate-functional monomer, for example, carbamated propyl acrylic monomer, with the other co-monomers in water. The aqueous mixture is provided having a suitable surfactant along with an appropriate polymerization initiator such as, for example, ammonium persulfate. Alternatively, using a secondary dispersion process, the carbamate-functional monomer is polymerized with acid-functional and other co-monomers in an appropriate solvent solution. The solvent solution is subsequently titrated with an appropriate amine and neutralized. The resulting polymer salt is then added into water to form an aqueous dispersion that can be used in clearcoat coating compositions, basecoat coating compositions, and pigment grind compositions. Non-limiting examples of such salting amines are dimethylethanol amine (DMEA), 2-amino-2-methyl propanol (AMP), ammonia, triethanolamine, triethyl amine, diethyl amine.

The solvent or solvent mixture is generally heated to the reaction temperature and the monomers and initiator(s) and optionally chain transfer agent(s) are added at a controlled rate over a period of time, typically from about two to about six hours. The polymerization reaction is usually carried out at temperatures from about 20° C. to about 200° C. The reaction may conveniently be done at the temperature at which the solvent or solvent mixture refluxes, although with proper control a temperature below the reflux may be maintained. The initiator should be chosen to match the temperature at which the reaction is carried out, so that the half-life of the initiator at that temperature should preferably be no more than about thirty minutes, more preferably no more than about five minutes. Additional solvent may be added concurrently. The mixture is usually held at the reaction temperature after the additions are completed for a period of time to complete the polymerization. Optionally, additional initiator may be added to ensure complete conversion of monomers to polymer.

Typical initiators are organic peroxides such as dialkyl peroxides such as di-t-butyl peroxide, peroxyesters such as t-butyl peroctoate and t-butyl peracetate, peroxydicarbonates, diacyl peroxides, hydroperoxides such as t-butyl hydroperoxide, and peroxyketals; azo compounds such as 2,2′azobis(2-methylbutanenitrile) and 1,1′-azobis(cyclohexanecarbonitrile); and combinations of these. Typical chain transfer agents are mercaptans such as octyl mercaptan, n- or tert-dodecyl mercaptan; halogenated compounds, thiosalicylic acid, mercaptoacetic acid, mercaptoethanol, and dimeric alpha-methyl styrene.

Although aqueous coating compositions that are free of regulated volatile organic compounds (VOCs) are preferred, a solvent may optionally be utilized in the coating composition used in the practice of the present invention. In general, the solvent can be any organic solvent and/or water. In one preferred embodiment, the solvent includes a polar organic solvent. More preferably, the solvent includes one or more organic solvents selected from polar aliphatic solvents or polar aromatic solvents. Still more preferably, the solvent includes a ketone, ester, acetate, aprotic amide, aprotic sulfoxide, or a combination of any of these. Examples of useful solvents include, without limitation, methyl ethyl ketone, methyl isobutyl ketone, m-amyl acetate, ethylene glycol butyl ether acetate, propylene glycol monomethyl ether acetate, xylene, N-methylpyrrolidone, blends of aromatic hydrocarbons, and mixtures of these. In another preferred embodiment, the solvent is water or a mixture of water with small amounts of co-solvents.

In general, the co-solvents are water-miscible organic solvents that can be up to about 50% by weight, based on the total amount of volatile materials (i.e., water plus organic solvents). In a preferred embodiment, the water is at least about 10%, more preferably at least about 15%, still more preferably at least about 20%, and even more preferably at least about 25% by weight of the total amount of volatile material.

The organic phase of the coating composition includes the polymer having a sufficient amount of the carboxylic acid and carbamate-functionalities and a sufficient amount of the water-miscible organic solvent to form a colloidal emulsion of the water. The organic phase further includes a low hydrogen bonding oxygenated solvent, which advantageously reduces the viscosity of the coating composition.

In a preferred embodiment, the coating composition has a viscosity is 200 centipoise or less. Coating compositions at this viscosity can be applied using the same application equipment as is used with traditional high solids coating technology. Accordingly, the monomers used to prepare the acrylic or other polymer are selected and apportioned to achieve the desired viscosity, and in conjunction therewith the molecular weight of the polymer and the water-miscible solvent or solvent blend are likewise selected to achieve the desired viscosity.

The volatile organic content (VOC) of the coating composition, as measured according to EPA Method 24, is preferably about 3.5 lbs./gal. or less, more preferably about 3.2 lbs./gal. or less, and even more preferably about 3.0 lbs./gal. or less (without water). (VOC values used herein are those calculated without water.) The VOC is minimized as much as possible by using the minimum amount of organic solvent along with the maximum amount of water to obtain the desired viscosity.

The coating composition preferably contains one or more crosslinking agents that react with the acrylic polymer after the coating composition is applied to form a cured coating. The composition preferably includes at least one crosslinking agent that is reactive with carbamate-functionality. The crosslinking agents have two or more groups reactive with the polymer, and the crosslinker advantageously has affinity for water. That is, the crosslinking agents preferably have a polar group or groups. A certain amount of crosslinking agents without affinity for water may also be included.

The crosslinker may be monomeric, oligomeric, or polymeric. Examples of suitable crosslinking agents include, without limitation, aminoplast crosslinkers The aminoplast crosslinker is advantageously a monomeric, preferably partially alkylated, particularly preferably partially methylated, melamine formaldehyde resin. Melamine formaldehyde resins having imino content are also useful.

The clearcoat composition includes preferably at least about 10% by weight, more preferably at least about 15% by weight, of the crosslinker, based on the nonvolatile vehicle. “Non-volatile vehicle” refers to the film forming components. In preferred embodiments, the crosslinker is at least about 5%, more preferably at least about 10% by weight of the nonvolatile vehicle. It is also preferred for the crosslinker to be up to about 40%, more preferably up to about 30% by weight of the nonvolatile vehicle. The crosslinker is preferably from about 5% to about 40%, more preferably from about 10% to about 35%, and still more preferably from about 15% to about 35% by weight of the nonvolatile vehicle.

The clearcoat coating composition may include one or more catalysts to enhance the cure reaction, and preferably include at least one catalyst for the aminoplast curing agent reaction and one catalyst for the polyisocyanate curing agent reaction. Suitable catalysts for the aminoplast curing agent reactions include, without limitation, alkylsulfonic acids, arylsulfonic acid, and alkylarylsulfonic acids, such as methane sulfonic acid, p-toluene sulfonic acid, dinonylnaphthalene disulfonic acid, dodecylbenzenesulfonic acid; phosphoric acid and its esters such as phenyl acid phosphate, butyl phosphate, and hydroxy phosphate esters; monobutyl maleate, boron trifluoride etherate, trimellitic acid, and triflic acid. Strong acid catalysts are often blocked, e.g. with an amine.

Additional agents, for example surfactants, stabilizers, wetting agents, rheology control agents, fillers, pigments, colorants, fungicides, dispersing agents, adhesion promoters, UV absorbers, hindered amine light stabilizers, and the like as known to those skilled in the art of coating formulations may be included and are contemplated as within the scope of the invention. While such additives are well-known in the prior art, the amount used must be controlled to avoid adversely affecting the coating characteristics.

In various embodiments, the coating of the present invention is applied to polycarbonate substrates. The invention provides a high level of adhesion between the cured coating and the polycarbonate substrate while avoiding or minimizing the use of non-reactive volatile components, such as solvents. Preferred polycarbonate substrates for use with the present invention include thermoplastic polycarbonate materials. Typical examples of polycarbonate resins are obtained by the reaction of aromatic dihydroxy compounds with phosgene, as well as those obtained by the reaction of aromatic dihydroxy compounds with carbamate precursors such as diaryl carbonates. The term “polycarbonate resin” is also meant to include aromatic polycarbonate resins, including polyester carbonates obtained from the reaction products of a dihydroxy phenol, a carbamate precursor and a dicarboxylic acid such as terephthalic acid and isophthalic acid.

In a preferred embodiment, the coating composition of the invention is a coating composition for an automotive vehicle or part thereof. Portions of the automobile may include polycarbonate materials, as well as steel and other materials commonly used in the industry. Among the kinds of useful automotive coating compositions are primers and primer surfacers, topcoats, basecoats, and clearcoats. Clearcoats are particularly preferred.

The coating compositions can be coated on an article of a vehicle, or another substrate, by any of a number of techniques well-known in the art. These include, for example, spray coating, dip coating, roll coating, curtain coating, and the like. For automotive body panels and the like, spray coating is preferred.

In various embodiments, the coating composition is used as the clearcoat of a composite color-plus-clear coating. The pigmented basecoat composition over which it is applied may be any of a number of types well-known in the art, and does not require explanation in detail herein. Polymers known in the art to be useful in basecoat compositions include acrylics, vinyls, polyurethanes, polycarbonates, polyesters, alkyds, and polysiloxanes. Preferred polymers include acrylics and polyurethanes. In one preferred embodiment of the invention, the basecoat composition also utilizes a carbamate-functional acrylic polymer. Basecoat polymers may be thermoplastic, but are preferably crosslinkable and comprise one or more type of crosslinkable functional groups. Such groups include, for example, hydroxy, isocyanate, amine, epoxy, acrylate, vinyl, silane, and acetoacetate groups. These groups may be masked or blocked in such a way so that they are unblocked and available for the crosslinking reaction under the desired curing conditions, generally elevated temperatures. Useful crosslinkable functional groups include epoxy, acid, anhydride, silane, and acetoacetate groups. Preferred crosslinkable functional groups include hydroxy functional groups, acid-functional groups, and amino functional groups.

Basecoat polymers may be self-crosslinkable, or may require a separate crosslinking agent that is reactive with the functional groups of the polymer. When the polymer comprises hydroxy functional groups, for example, the crosslinking agent may be an aminoplast resin, isocyanate and blocked isocyanates (including isocyanurates), and acid or anhydride functional crosslinking agents.

The clearcoat coating composition is generally applied wet-on-wet over a basecoat coating composition as is widely done in the industry. One preferred embodiment provides a method of coating a polycarbonate substrate with the aqueous dispersion of the present invention. The aqueous dispersion may be a basecoat coating composition or a clearcoat coating composition. It is contemplated that both the basecoat and clearcoat coating compositions comprise aqueous dispersions. In various embodiments, a substrate is first coated with a primer, such as an electroconductive primer coating known in the art. A basecoat coating composition is applied over the primed substrate and may be flashed for a short period of time. The clearcoat coating composition is then applied over the basecoat coating. The clearcoat coating is allowed to flash for a short period of time prior to being baked and curing to form a composite coating layer. If the substrate is a polycarbonate, the clearcoat can be applied directly on the substrate without any primer or basecoat.

The coating compositions described herein are preferably subjected to conditions so as to cure the coating layers. Although various methods of curing may be used, heat curing is preferred. Generally, heat curing is effected by exposing the coated article to elevated temperatures provided primarily by radiative heat sources. Curing temperatures will vary depending on the particular blocking groups used in the crosslinking agents; however they generally range between 90° C. and 180° C. In a preferred embodiment, the cure temperature is preferably between 115° C. and 150° C., and more preferably at temperatures between 115° C. and 140° C. for a blocked acid catalyzed system. For an unblocked acid catalyzed system, the cure temperature is preferably between 80° C. and 100° C. The curing time will vary depending on the particular components used, and physical parameters such as the thickness of the layers; however, typical curing times range from 15 to 60 minutes, and preferably 15 to 25 minutes for blocked acid catalyzed systems and 10 to 20 minutes for unblocked acid catalyzed systems. The curing times may also be expressed as time after metal temperature reaches the bake temperature (“metal temperature”). For example, the curing time may be for 5 to 60 minutes, preferably 10 to 30 minutes.

Once cured, a clearcoat over basecoat composite of the present invention yields a film having high etch performance and adhesion. Unlike similar formulations in the prior art, the present invention provides a coating suitable for application over polycarbonate that is highly glossy and transparent with minimal haze and has a high level of solvent resistance.

The clearcoat coating composition may include further carbamate-functional compounds. Such carbamate-functional compounds include, without limitation, any of those described in U.S. Pat. Nos. 6,160,058, 6,084,038, 6,080,825, 5,994,479, the disclosures of which are incorporated by reference. In particular, the composition may include a carbamate-functional or urea-functional material comprising at least two functional groups, at least one of which is a carbamate or urea group that is the reaction product of (1) an hydroxyl group of a first compound that is the result of a ring-opening reaction between a compound with an epoxy group and a compound with an organic acid group and (2) cyanic acid or a carbamate or urea group-containing compound.

The coating composition may include a further resinous material, for example one or more of the carbamate-functional materials described in Ohrbom, et al., U.S. Pat. No. 6,165,618; Green, et al., U.S. Pat. No. 5,872,195; McGee, et al., U.S. Pat. No. 5,854,385; Green, et al., U.S. Pat. No. 5,852,136; Ohrbom, et al., U.S. Pat. No. 5,827,930; Menovcik, et al., U.S. Pat. No. 5,792,810; McGee, et al., U.S. Pat. No. 5,770,650; Ohrbom, et al., U.S. Pat. No. 5,766,769; Bammel, et al., U.S. Pat. No. 5,760,127; Menovcik, et al., U.S. Pat. No. 5,744,550; Rehfuss, et al., U.S. Pat. No. 5,719,237; Green, U.S. Pat. No. 5,693,724; Green, U.S. Pat. No. 5,693,723; Menovcik, U.S. Pat. No. 5,659,003; Briggs, U.S. Pat. No. 5,639,828; Rehfuss, et al., U.S. Pat. No. 5,336,566; Ohrbom, et al., U.S. Pat. No. 6,541,594; and Ohrbom, et al., U.S. Pat. No. 6,362,285, each of which is incorporated herein by reference. The carbamate-functional material can be a compound or an oligomer (that is, with up to ten or so repeating monomer units). Preferably, the carbamate-functional material has a molecular weight (for a compound), or number average molecular weight (for an oligomer) of up to about 2,000, preferably up to about 1,800.

Primer and primer surfacer compositions may further include one or more pigments and typically include one or more fillers. Basecoat and one layer topcoat compositions further include one or more color pigments and/or one or more special effect pigments, including metallic flake pigments and pearlescent pigments. Clearcoat compositions may be tinted.

The invention is further described in the following examples. The examples are merely illustrative and do not in any way limit the scope of the invention as described and claimed.

Acrylic Polymers with Carbamate Monomer (Water-Borne):

Polymer 1.

TABLE 1

| Ingredient | Amount (g) |
|---|---|
| Acrylic acid | 16.7 |
| n-butyl methacrylate | 63.9 |
| t-butyl peroxy acetate (50% in | 10.7 |
| mineral spirits) | |
| Carbamate propyl acrylate | 54.8 |
| Deionized water | 168.4 |
| Dimethylethanolamine | 12.4 |
| 2-ethylhexyl acrylate | 68.6 |
| Mineral spirits | 10.5 |
| Propylene glycol monopropyl ether | 103.2 |
| Styrene | 64.7 |

To a reactor containing 94.8 g of propylene glycol monopropyl ether at 140° C., a mixture of 16.7 g of acrylic acid, 54.8 g of carbamate propyl acrylate, 63.9 g of n-butyl methacrylate, 68.6 g of 2-ethylhexyl acrylate, 64.7 g of styrene in 8.4 g of propylene glycol monopropyl ether and 6.7 g of t-butyl peroxy acetate (50% in mineral spirits) and 6.5 g of mineral spirits is added over four hours. After a hold period of about 30 minutes, a mixture of 4 g of t-butyl peroxy acetate and 4 g of mineral spirits is added over an additional 30 minutes to complete the reaction. After a further hold period of about 1 hour, the contents are cooled to 70° C. and 12.4 g of dimethylethanolamine and 8.4 g of deionized water are added. After about 20 minutes of stirring, 160 g of deionized water is loaded, yielding a water dispersed resin at 28% solids. GPC molecular weight (measured against a polystyrene standard) is found to be about Mₙ 5,750, M_{w} 14,440 with a polydispersity of 2.5. Equivalent weight is calculated to be 850 g/carbamate and the amount of neutralization was 60%. The theoretical T_{g} of the resin (determined using the Fox equation) is 22.9° C.

Polymer 2.

TABLE 2

| Ingredient | Amount (g) |
|---|---|
| Acrylic acid | 36.2 |
| n-butyl acrylate | 111.3 |
| t-butyl peroxy 2-ethylhexanoate | 5.7 |
| Carbamate propyl acrylate | 59.5 |
| Deionized water | 520 |
| 2-ethylhexyl methacrylate | 61 |
| Ethylene glycol monobutyl ether | 130.6 |
| Styrene | 32.5 |

To a mixture of 95 g of butyl cellosolve and 20 g of deionized water in a reactor kept at 105° C., a mixture of 59.5 g of carbamate propyl acrylate, 61 g of 2-ethylhexyl methacrylate, 36.2 g of acrylic acid, 32.5 g of styrene, 111.3 g of n-butyl acrylate in 1 g ethylene glycol monobutyl ether, and 4.7 g of t-butyl peroxy 2-ethylhexanoate in 23 g of ethylene glycol monobutyl ether is added over 3 hours. After about a 30 minute hold period, 1.2 g of t-butyl peroxy 2-ethylhexanoate in 11.6 g of butyl cellosolve is added over about 30 minutes to complete the reaction. After a further hold period of about 1 hour, the reactor is cooled to about 70° C. and 30.1 g of dimethylethanolamine in 1 g of ethylene glycol monobutyl ether is added. After stirring for 30 minutes, it is dispersed into 500 g of deionized water to obtain a water dispersed resin at 30% NV having an equivalent weight of 870 g/carbamate. It is neutralized at 68% and has a theoretical T_{g} (determined using the Fox equation) of 1.1° C. GPC molecular weight (measured against a polystyrene standard) is found to be about Mₙ 6,120, M_{w} 13,870 with a polydispersity 2.3.

Polymer 3.

TABLE 3

| | Amount |
|---|---|
| Ingredient | (g) |
| 20% 2-amino-2-methyl-1-propanol | 21.8 |
| Abex ® EP-110 surfactant | 6.1 |
| Ammonium persulfate | 0.9 |
| n-butyl acrylate | 203 |
| n-butyl methacrylate | 50 |
| Carbamate propyl acrylate | 36.3 |
| Deionized water | 543.8 |
| 2-ethylhexyl alcohol | 14.5 |
| Methyl methacrylate | 67.9 |
| Pluracol ® P410 | 11.4 |

To 308.5 g of deionized water in a reactor kept at 90° C., a well agitated mixture of 188 g of deionized water, 6.1 g of Abex® EP-110 surfactant (available from Alcolac Inc.), 36.3 g of carbamate propyl acrylate, 203 g of n-butyl acrylate, 50 g of n-butyl methacrylate, 67.9 g of methyl methacrylate, and 0.9 g of ammonium persulfate in 36.3 g of deionized water is added over 2.5 hours. The reaction mixture is held at 90° C. for 2 more hours and then cooled to 35° C. 21.8 g of 20% 2-amino-2-methyl-1-propanol in deionized water, 11.4 g of Pluracol® P410 (available from BASF Corporation), 14.5 g of 2-ethylhexyl alcohol and 11 g of deionized water is added to achieve a final emulsion at 35.5% solids. The theoretical T_{g} of the resin (determined using the Fox equation) is −13.4° C., and the equivalent weight is 1,740 g/carbamate.

TABLE 4

| | | |
|---|---|---|
| Coating 1 | Coating 2 | Coating 3 |

| | | | | | | |
|---|---|---|---|---|---|---|
| Polymer 1 | 30 | g | | | | |
| Polymer 2 | | | 32 | g | | |
| Polymer 3 | | | | | 30 | g |
| Hexamethoxy- | 1 | g | 1 | g | 0.5 | g |
| methylmelamine | | | | | | |
| (HMMM) | | | | | | |
| Dodecylbenzene | 0.05 | g | 0.05 | g | 0.05 | g |
| Sulfonic Acid | | | | | | |
| (DDBSA) | | | | | | |

Draw-downs (4 mil) are made on polycarbonate sheets with coating compositions formulated as presented in Table 4. After 10 minutes of room temperature flash, the films are cured by heating them at 110° C. for 45 minutes. The films are very clear, glossy, and withstand over 20 isopropanol double rubs, over 200 deionized water double rubs. After applying a cross-hatch of cuts, they do not show any pick up of loose paint films, as evidence that the coatings have good adhesion to the polycarbonate substrate.

The invention has been described in detail with reference to preferred embodiments thereof. It should be understood, however, that variations and modifications can be made within the spirit and scope of the invention.

What is claimed is:

1. A process for coating a substrate with a low VOC emission composite coating, the process comprising:
applying a primer coating composition over a substrate and curing the primer coating composition to form a primer coating layer;
applying a basecoat coating composition over the primer coating layer;
applying a clearcoat coating composition over the basecoat coating composition; and
curing the applied basecoat and clearcoat coating compositions to form a composite coating layer,
wherein at least one of the primer coating composition, the basecoat coating composition, and the clearcoat coating composition comprises a water based dispersion comprising an aqueous emulsion of copolymerized (meth)acrylate monomers and carbamate-functional monomers, the dispersion further being essentially free of hydroxyl monomer.

2. The process according to claim 1, wherein the dispersion is prepared by emulsion copolymerizing at least one monomer selected from the group consisting of

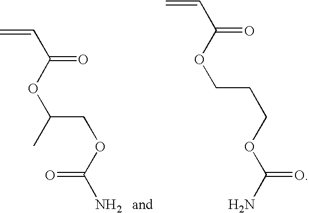

3. The process according to claim 1, wherein the dispersion is prepared by copolymerizing carbamate propyl(meth)acrylate and an acid-functional co-monomer in a solvent, salting the resulting polymer with an amine, and adding water to form an aqueous dispersion.

4. The process according to claim 1, wherein the primer coating layer is electroconductive.

5. The process according to claim 1, wherein the substrate comprises polycarbonate.

6. The process according to claim 1, further comprising the use of at least one crosslinker reactive with carbamate-functionality.

7. The process according to claim 6, wherein the crosslinker is an aminoplast.

8. A method of coating a polycarbonate substrate, the method comprising:
preparing an aqueous dispersion of copolymerized carbamate-functional monomer and (meth)acrylic co-monomers essentially free of hydroxyl monomer;
adding at least one crosslinker;
applying the composition to a polycarbonate substrate; and
curing the composition.

9. The method according to claim 8, wherein the dispersion is prepared by copolymerizing at least one monomer selected from the group consisting of

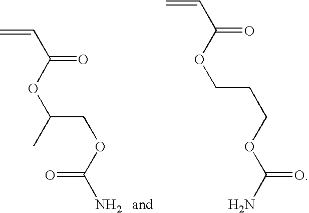

10. The method according to claim 8, wherein the aqueous dispersion is prepared by copolymerizing carbamate-functional monomer with at least one carboxylic acid-functional monomer in a solvent, salting the resulting polymer with an amine, and forming a dispersion in water.

11. The method according to claim 8, further comprising mixing the dispersion with a hexamethoxymethylmelamine (HMMM) crosslinker and an acid catalyst.

12. The method according to claim 8, wherein the crosslinker comprises an aminoplast resin.

13. The method according to claim 8, further comprising copolymerizing a UV absorber.

14. A clearcoat coating made according to the method of claim 8.

15. A basecoat coating made according to the method of claim 8.
